(19) United States
(12) Patent Application Publication
(10) Pub. No.: US 2015/0282662 A1
(43) Pub. Date: Oct. 8, 2015

(54) STOP VALVE FOR COFFEE MAKER

(71) Applicants: Harvey LEVINE, (US); Lawrence T. LEVINE, (US)

(72) Inventors: Harvey Levine, Fairfield, CT (US); Lawrence T. Levine, Easton, CT (US)

(21) Appl. No.: 14/437,282

(22) PCT Filed: Nov. 12, 2013
(86) PCT No.: PCT/US2013/069648

§ 371 Date: Apr. 21, 2015

Related U.S. Application Data
(60) Provisional application No. 61/725,554, filed on Nov. 13, 2012.

(51) Int. Cl. A47J 31/10; A23F 5/26

(52) U.S. Cl. CPC A47J 31/106; A23F 5/262

(57) ABSTRACT

Drip coffee makers include a one way valve to control a flow of fresh water from a reservoir into a heating conduit via a cold water conduit. Water is heated in the heating conduit, and then proceeds into a hot water conduit, and hot water is thereafter spread over coffee grounds by a showerhead. Heating water causes formation of steam and pressure in the hot water conduit. The one way valve prevents the heated water from moving backwards towards the reservoir, helping force the water onward through the system towards the coffee grounds in the filter basket. Once the heated steam and water move out of the heating conduit the one-way valve is able to open and new fresh water enters. The one-way valves use heavy metal or steel valve stoppers. The stoppers may be spherical, columnar, bullet shaped, or a pair of spheres either loose or fused.

### RELATED APPLICATION

This application claims the benefit of U.S. Provisional Patent Application No. 61/725,554, filed Nov. 13, 2012, which is fully incorporated by reference herein.

### FIELD AND BACKGROUND OF THE INVENTION

The present invention relates generally to the field of kitchen appliances, and in particular to drip coffee makers, and to valves for controlling water flow through coffee makers.

Drip brewing coffee involves pouring water over roasted, ground coffee beans contained in a filter. Hot water seeps through the ground coffee, absorbing its color and flavors and, pulled by gravity, then passes through a filter. The used coffee grounds are retained in the filter with the flavored liquid dripping into a collecting vessel below such as a carafe or pot. Drip brewing is a widely used method of coffee brewing, and is popular for both home and commercial use. Manual drip-brewing devices exist, although electrical units which transform cold water into hot coffee in a single process are more popular. Small, single-cup drip brew coffee makers also exist and can be either manual or electrical.

An electric drip coffee maker typically works by admitting water from a cold water reservoir into a flexible hose in the base of the reservoir which leads to a thin metal tube or other heating chamber, which may be aluminum. A heating element surrounding or adjacent to the heating chamber heats the water. A thermostat may be attached to the heating element to switch off the heating element when needed to prevent overheating, and to turn the element back on when the temperature falls below a threshold level.

Heated water may move through the device using the thermosiphon principle. A “thermosiphon” refers to a method of passive heat exchange based on natural convection, which circulates a substance (liquid or gas) without the necessity of a mechanical pump. Thermosiphoning is also used for circulation of liquids and volatile gases in heating and cooling applications, such as heat pumps, water heaters, boilers and furnaces.

Heated water in the heating chamber expands and pressurizes the chamber. In an electric drip coffee maker, thermally-induced pressure combined with a siphoning effect moves heated water and/or steam out of the tubular heating chamber, typically via an insulated rubber or vinyl riser hose. A one-way valve prevents hot water from moving backwards towards the reservoir. After leaving the heater the hot water continues upwards to a spray head. Hot water then rains down from the spray head, through a plurality of holes, and onto ground coffee below. Typically the coffee is contained in a filter-lined basket mounted below the spray head. Hot coffee passes through a filter, leaving the grounds behind, and drips down into a container such as a carafe.

The optimal water temperature to brew coffee most widely accepted by the coffee industry is between 195° F. and 205° F. This range has been reported by the Coffee Brewing Institute of the Pan-American Coffee Bureau, the Coffee Brewing Center in its Equipment Evaluation Publication No. 126, in New York in 1966, and the Norwegian Coffee Brewing Center in its Evaluation and Approval of Home Coffee Makers Publication No. 6B in 1980, among other sources. This temperature range refers to the temperature of the water released from the showerhead of an automatic drip coffee maker that wets the coffee grounds in the basket of the coffee maker so that the best tasting coffee can be extracted.

The fresh water that is poured into the reservoir of an automatic drip coffee maker is at room temperature, if not colder. Therefore, the faster the heating system can raise the temperature of the water hitting the coffee grounds to the optimal range, the better the quality of the resulting brew. Coffee extracted using lower temperature water is, all things being equal, usually inferior.

The performance of conventional drip coffee makers is generally faulted because they take a long time to raise the temperature of the water delivered to the grounds to the optimal range. This problem is especially pronounced with smaller coffee makers, such as those yielding five cups or less, because the input wattage and the total time available to heat the system and brew the coffee are less than with full-size machines. In some coffee makers the water temperatures does not reach the optimal range until the very end of a brewing cycle, by which time much of the brew has already been produced at sub-optimal temperatures.

More powerful heating elements and larger heating chambers can be provided to heat larger amounts of water more quickly for larger coffee makers. Higher powered and larger heating elements are one method of delivering hotter water to the coffee grounds, but larger and high-powered heaters are not always desirable, economical, or practical. Undesirable effects can include incomplete extraction, and excess steam generation. Alternative methods to for quickly heating water to between about 195° F. and 205° F. are therefore desirable, particularly for smaller and lower-powered coffee makers.

The pressure created by hot water in the heating chamber will push both forwards, towards the shower head and coffee grounds, and backwards, in the direction of the cold water reservoir. Typically a one-way valve in the tubing prevents water in the heating element from siphoning back towards the reservoir despite the bi-directional pressure in the heating element. This valve is often a simple check valve, particularly a ball check valve, positioned in the tubular path between the reservoir and the heating element.

A check valve, clack valve, non-return valve or one-way valve is a valve that substantially only allows liquid or gas to flow through it in a single direction. Check valves are two-port valves, meaning they have two openings in the body, one for fluid to enter and the other for fluid to leave. Different types of check valves are used in different applications. Although available in a wide range of sizes and costs, check valves are typically small, simple, and relatively inexpensive. Check valves usually work automatically, without the need for external control by a person or otherwise. Accordingly, most check valves do not include a valve handle or stem. The bodies or external shells of check valves are often made of plastic or metal.

“Cracking pressure” is the minimum downstream pressure at which a check valve will operate by letting fluid through in the “correct” direction for that one-way valve. If there is less pressure than the cracking pressure the valve remains closed, such as by a valve ball sitting in its ball seat to block the passage of water. Above the cracking pressure the valve will be open, such as by a ball moving away from its seat allowing water to pass. A check valve may be designed to have a specific cracking pressure.

A ball check valve is a type of check valve in which the closing member, i.e. the movable part which blocks the flow of liquid, is a spherical ball. In some variations the ball is spring-loaded to help keep it shut, thus increasing the cracking pressure. In designs without a spring, reverse flow pressure may be required to move the ball back towards the seat and create a seal. The interior surface of the main seat in ball check valves is typically more or less conical, being tapered to guide the ball into the seat to form a seal between the ball and the seat to stop reverse flow. Water flow in the desired direction, and in some arrangements gravity, pushes the ball away from the seat, opening the valve. Water flow or pressure in the undesired, upstream, or backwards direction pushes the ball back into the seat, closing the valve.

Ball check valves are often small, simple, and inexpensive. Conventional drip coffee makers, made in the millions of units every year for the past several decades, feature a one-way valve with a very lightweight, typically plastic or glass, rounded ball or bead.

A swing check valve or tilting disc check valve is another type of check valve where a disc or other “cover” is the movable part to block the flow of liquid. The disc pivots on a hinge or trunnion, either onto a seat and over and opening to block reverse flow, or off the seat to allow forward flow through the opening. Swing check valves may be analogous to a door which swings outwards but not inwards. The swing check valve can be arranged so that the pressure of fluid in the desired flow direction swings the cover open, while fluid moving in the backwards, undesired direction swings and holds the cover shut. While swing check valves can come in a variety of sizes, large check valves are more often swing check valves as opposed to ball valves. The flapper valve in a flush-toilet mechanism is an example of a swing check valve. Means such as a spring bar, press bar, or other resilient element may be provided to bias the cover towards the closed position to increase the cracking pressure. Two or more separately pivoting surfaces may be provided to open and close a single opening, analogous to a set of double doors.

U.S. Pat. No. 4,142,840 discloses a generally C-shaped coffee maker having a heated carafe, a water spreader, and an accessible water reservoir having an apertured bottom wall. The housing has a pump and heated chamber in the bottom for delivering heated water to the spreader, and a tubular outer conduit connecting the reservoir and chamber with a concentric spaced inner conduit between the chamber and reservoir interior. An integral one way valve is provided on the inner conduit between the conduits and the chamber permitting cold water into the chamber through the outer conduit and hot water exit through the inner conduit.

U.S. Pat. No. 4,744,291 describes a drip coffee maker which uses a traditional round ball in a ball check valve to control the flow of fresh water into a heating conduit. By rotating a shaft, the movement of the valve ball away from the seat can be enlarged or reduced to control the size of the water passage between the ball and the valve ball seat.

U.S. Pat. No. 4,361,750 describes a drip coffee maker having a condenser for eliminating delivery of steam to the water spreader. Check valves may be supplied either at the reservoir outlet or the hot water generator outlet or both to act as one-way valves.

U.S. Pat. No. 5,724,883 describes a typical prior art drip coffee maker including a ball valve, which description is incorporated by reference into this disclosure. Fresh water is placed in a reservoir and is fed, in metered amounts, through a drain and into inlet tubing. The drain can include a check valve or a ball valve device. Such valves generally include a ball and spring which selectively permit water to pass through depending on the pressure on the heater side of the valve downstream from the reservoir. When there is no water in the heater tubing of heater assembly, the valve opens due to the pressure of the water in the reservoir pushing the valve open, which pressure is greater than the spring force which holds the ball in a sealing arrangement with the inlet to the valve. As the ball is forced downward away from the inlet seal, water enters the water inlet tubing and then the heater water tubing. When a sufficient amount of water enters the heater water tubing, the ball valve closes and water within the heater water tubing is heated by a resistance heater. The water in the heater tubing is rapidly converted to steam and is expelled from tubing through outlet tubing, and up through a riser tube.

U.S. Pat. No. 5,724,883 further explains that steam expelled upward through a riser tube enters a shower assembly where the steam recondenses to water. The hot water then drips through openings in shower assembly, and falls onto the coffee grounds in filter basket. A filter may be provided to hold the grounds. The hot water can then steep in the filter basket to create the hot brewed beverage. As the filter basket fills with water, the brewed beverage exits the filter basket at filter basket outlet where it passes into a carafe.

U.S. Pat. No. 7,858,134 describes a system that allows for hot water on demand. Once the water is heated, it is delivered to flavor containing solid material, which may be coffee, in a pressurized pulse. By heating the water on demand, a more uniform temperature is achieved and by delivering the heated water in a pressurized pulse, the extraction of flavor from the flavor containing solid material is greatly improved. Check valve balls are used to control water movement.

U.S. Pat. No. 7,281,467 teaches an apparatus for generating and delivering a pressurized hot water pulse to a brewing station for making coffee. The disclosure states that the best brewing temperature for coffee is 192° to 205° F., and that it is difficult to achieve this temperature with automatic drip coffee makers, especially lower capacity units. Extraction temperature and time are among the most critical considerations when brewing coffee. Automatic drip coffee makers brew better coffee than percolators by avoiding re-boiling coffee and reducing extraction time, thus preserving the aroma and reducing coffee bitterness because the bitter, less soluble chemicals in the grounds require longer extraction time. Shorter extraction time, however, normally causes incomplete extraction, which contributes to the weaker coffee often made by single-cup drip coffee makers.

Thus, there is a need for improved drip coffee makers which provide hot water at between 195° and 205° F. earlier in the brewing cycle to provide better extraction and improved flavor than drip coffee maker which take longer to reach the desired range.

### SUMMARY OF THE INVENTION

Using a stop valve with a lightweight ball piston, as is currently done in essentially all production-level automatic drip coffee makers, results in significant variations in brewing temperature and level of coffee extraction among different coffee makers, particularly those having different cup capacities and wattages.

It is an object of the present invention to simply and cost-effectively modify existing automatic drip coffee makers, including small capacity ones, so that the water in these coffee makers reaches the optimal coffee brewing temperature of between about 195 and 205° F. faster than is possible with the current technology. The improved valves in particular allow these coffee makers to extract a much better brew by allowing the water temperature to reach the preferred temperature range faster than is possible using prior art coffee makers of comparable size and power. By delivering water over 195° F. early in the brew cycle, a given level of flavor can also be achieved using less coffee, providing increased efficiency. Another advantage is that coffee reaching the carafe or pot will be at a higher temperature; low coffee temperature is a common complaint regarding prior art drip coffee makers.

Accordingly, improved one-way valves are provided as an improvement on and alternative to the valves that are commonly found between the coffee maker's reservoir and its heating system. In many cases, this one-way valve is inserted in or attached to a tube that connects the reservoir to one end of the heating system. The rounded ball or bead in the one-way valve presses against the opening of the valve closest to the reservoir when the heating system makes the water flash to steam. This action causes that end of the one-way valve to be sealed, and the heated water to be pushed in the opposite direction up the tube attached to the other end of the heating system, out the showerhead, and onto the coffee grounds.

The inventors have found that the weight and the distance of travel of the moving, rounded ball or bead in the one-way valve are critical variables to controlling how quickly the temperature of the water reaches the optimal brewing range. For instance, changing the lightweight plastic or glass, rounded glass ball or bead to a steel ball helps decrease the time needed to reach the optimal temperature. Retaining the top of the rounded ball or bead and elongating the bottom of the rounded ball or bead to the shape of a longer column, pill, or bullet speeds the rate of the increase in temperature even further. The Applicants have discovered that columnar, bullet-shaped, or pill shaped valve stoppers work substantially better than traditional balls in ball stop valves for drip coffee makers.

Consequently, this disclosure discusses one-way valve systems for use in coffee makers with either one or more heavier balls, or with a columnar-shaped, relatively-heavy valve stops with a generally hemispherical or conically-shaped top. The invention also includes valve housings for use with the improved balls and pistons. The improved ball-type valve systems allow water to flow into one end of the heating system from the reservoir, but effectively close off the opening of the valve at the reservoir to block backwards egress of boiling water and/or steam from the heating system. This forces the boiling water up a tube at the other end of the heating system, out the showerhead and onto the coffee grounds. The improved valves consistently yield hotter water more quickly for reaching the coffee grounds. The valves help deliver hot water within the optimal water temperature range more quickly, earlier in the brewing cycle, than the prior art one-way valve systems used in most automatic drip coffee makers on the market today.

Therefore, in one aspect of the invention, a drip coffee maker is provided. The drip coffee maker comprises a reservoir for holding fresh water, a fresh water passage, the fresh water passage being connected to the reservoir for receiving fresh water from the reservoir, and a heating conduit, the heating conduit being in a base of the coffee maker, the heating conduit being elongated and being connected to the fresh water passage for receiving fresh water therefrom. A heating element is adjacent to the heating conduit, the heating element being linked to an electrical source and to a controller for controlling the coffee maker such as by turning it on and off. The heating element is capable of heating water in the heating conduit when the drip coffee maker is in operation, and may also heat coffee in a carafe above the base. A hot water passage is connected to the heating conduit for receiving hot water therefrom. The hot water passage leads to a shower head, the shower head being positioned over a filter basket for distributing hot water over the filter basket.

A one-way valve is positioned in the fresh water passage, the valve comprising a stopper and a housing, the valve being positioned so that fresh water traveling from the reservoir to the heating conduit passes through the valve. The valve is oriented so that any water moving backwards from the heating conduit towards the reservoir will bias the valve towards a closed configuration. Preferably the valve stopper is piston-shaped, is substantially made of steel, is from 0.4 to 0.6 inches long, weighs from 2.0 to 3.5 grams, and has a diameter from 0.2 to 0.3 inches. Preferably the valve housing has an inside length such that the stopper has an axial stroke length inside the housing of from 0.3 to 0.8 inches.

The valve housing typically comprises a valve seat, the valve seat being at an end of the valve which is closer to the reservoir than to the heating conduit. A portion of the valve stopper has a shape which is complimentary to the valve seat. The one-way valve is in the closed configuration when the stopper is engaged to the valve seat and substantially blocks passage of water through the valve.

The stopper may be bullet-shaped, having a generally flat end and a domed end at opposite ends of the stopper. Typically the domed end of the stopper is complimentary to, and oriented to engage with, the valve seat in the closed configuration.

A bullet-shaped stopper may be from 0.45-0.55 inches long and weighing from 2.7-3.3 grams. The valve housing may have an inside length such that the stopper has a stroke length of from 0.35 to 0.55 inches.

Preferably the stopper is metallic, ideally comprising steel. The stopper may be from 0.4 to 0.6 inches long, and have a diameter from 0.2 to 0.3 inches. The valve housing can have an inside length such that the stopper has an axial stroke length inside the housing of from 0.3 to 0.8 inches. The stopper may be metallic, from 0.4 to 0.6 inches long, and having a diameter from 0.2 to 0.3 inches. The valve housing may also have an inside length such that the stopper has an axial stroke length inside the housing of from 0.35 to 0.6 inches.

The drip coffee maker may have a capacity of at least eight cups, of 8-12 cups, of 8-10 cups, of about 10 cups, of at least ten cups, or of 10-12 cups. The coffee maker may also have a capacity of about five cups, of 3-5 cups, of less than 5 or less than 6 cups, or of 4-10 cups.

The coffee maker may include a stopper which is metallic, and weighs between 2.5-3.5 grams, or between 1.0 and 4.0 grams.

The drip coffee maker may use a valve housing having an inside length such that the stopper has an axial stroke length inside the housing of from 0.3 to 0.8 inches, wherein the coffee maker has a capacity of no more than five cups.

In another aspect of the invention, the valve stopper is bullet-shaped, having a generally flat end and a domed end. The bullet-shaped stopper is metallic, is from 0.2 to 0.7 inches long, and weighs from 1.0 to 4.0 grams. The bullet-shaped stopper can also be metallic, from 0.2 to 0.7 inches long, and weigh from 1.0 to 4.0 grams. The valve stroke length can be from 0.20 to 1.0 inches.

The invention also includes methods of brewing coffee by delivering hotter water to the grounds, via the showerhead, early in the brewing cycle. The methods typically use drip coffee makers of the present invention comprising improved valves, most preferably valves with elongated columnar stoppers.

A typical method comprises providing at least four cups of fresh water to the reservoir and then performing a brew cycle, thereby brewing at least four cups of coffee. The brew cycle typically comprises incrementally passing fresh water in the reservoir into the fresh water conduit, through the one-way valve, and into the heating conduit. The water in the heating conduit is heated, and then passed to the hot water passage, thence into the showerhead and onto coffee grounds below the showerhead. Advantageously the hot water delivered to the showerhead is at least 195° F. for at least half of the duration of the brew cycle.

In a variation on the brewing method, the coffee maker has a capacity of not more than five cups, and the valve housing has an inside length such that the stopper has an axial stroke length inside the housing of from 0.3 to 0.8 inches. Each brew cycle takes at least seven minutes, and the hot water delivered to the showerhead is at least 195° F. by the fourth minute of the brew cycle. In some aspects, the brew cycles is at least eight minutes or between eight and nine minutes long, and the hot water reaching the showerhead is at least 195° F. by the 4^{th} minute, and/or for more than half of the brew cycle. In another aspect the coffee maker has a capacity of about 4 cups or from three to five cups, the brew cycle is at least seven minutes, or least seven and a half minutes, or at least eight minutes long, and water reaching the showerhead is at least 195° F. by the 3rd minute or by the 4th minute. In yet another aspect of the invention, the coffee maker has a capacity of at least eight or at least ten cups, or from eight to ten or eight to twelve cups, the brew cycle is at least nine minutes long, and water reaching the showerhead is at least 195° F. by the 4^{th} minute.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a partially cross-sectional side elevational view of a drip coffee maker;

FIG. 2 is a schematic view of the path of water from a reservoir, through a one-way valve and a heating conduit, and to a shower head;

FIG. 3 is a bottom view of a coffee maker with the bottom panel removed to show the heating conduit;

FIG. 4a is a bottom perspective view of a prior art one-way ball valve;

FIG. 4b is a side view of the prior art ball valve in FIG. 4a;

FIG. 5 is aside view of a ball valve having an improved spherical steel stopper;

FIG. 6a is a side perspective view of a valve having a closed sided housing and a bullet-shaped columnar stopper;

FIG. 6b is an end perspective view of the housing of FIG. 6a showing the end where water leaves the one-way valve;

FIG. 6c is an opposite end perspective view of the housing of FIGS. 6a and 6b showing the end where water enters the one-way valve, including a passageway which can be blocked by a stopper in the closed valve state;

FIG. 7 is a side perspective view of a one-way valve including two unattached steel ball stoppers in a closed sided housing;

FIG. 8 is a side perspective view of a one-way valve including two conjoined steel balls as a stopper in a closed sided housing;

FIG. 9 shows three housings and three stoppers for use with the invention;

FIG. 10 is a bottom, side perspective view of a one-way valve having open sides and a bullet-shaped stopper;

FIG. 11 is a composite view of four improved stoppers;

FIG. 12 is a top, front, side perspective view of two valve housings of the invention; and

FIG. 13 shows side elevational views of the valve housings also shown in FIG. 12.

### DESCRIPTION OF THE PREFERRED EMBODIMENTS

There are a number of variables affect drip coffee maker brew cycles and brew temperatures. These include coffee maker size and cup capacity, the coffee maker wattage, the calibration and reset temperatures of the regulating thermostat controlling when the coffee maker is energized during the brewing cycle, the length and inside diameter of the stop valve body, the shape and weight of the piston, and the distance the piston travels inside the stop valve's body.

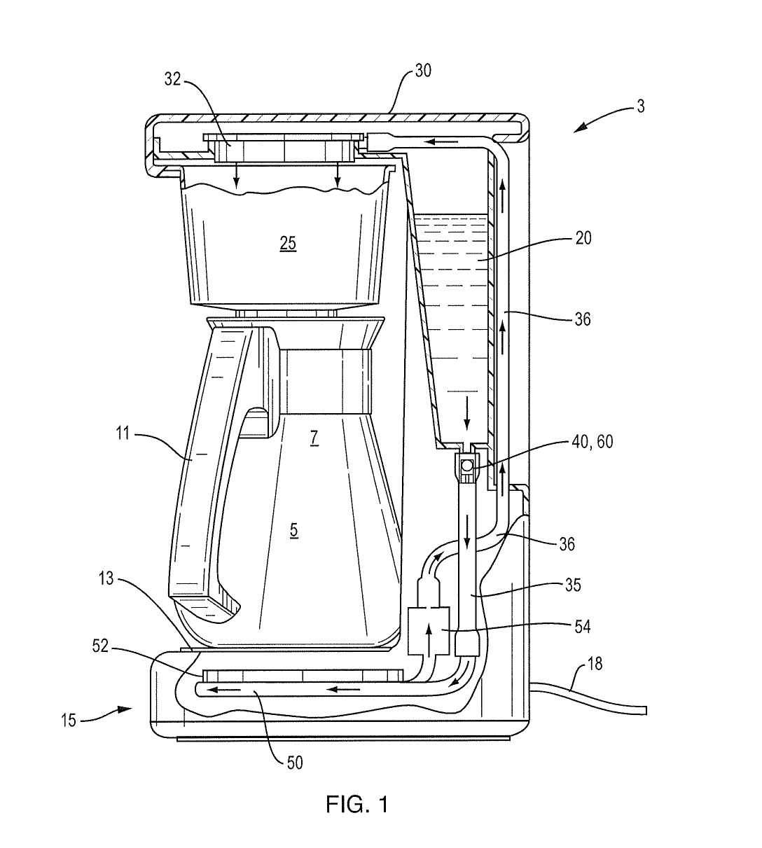

Referring now to the drawings, in which like reference numerals are used to refer to the same or similar elements, FIG. 1 shows partial cutaway of a drip coffee maker which can be used with the improved valves of the present invention. The coffee maker 1 comprises a body 3 and a carafe 5. The carafe is removable, and includes a container 7 having a handle 11 and optionally a lid on top. The carafe sits on top of a carafe heater 13 which is on top of a base 15 or seat portion 15 of the coffee maker. In the body 1 shown in FIG. 1, a reservoir 20 for holding fresh water is inside the top right portion. A filter basket 25 is provided for holding a filter and coffee grounds above the carafe. The reservoir and basket are accessible through one or two lids 30 at the top of the base. Means for controlling and heating water and for heating the carafe heater, which may be identical, are typically within the seat portion 15 of the body under the carafe. Controls to control the coffee maker may be on the body 3, and a power cord 18 for receiving electricity is shown. One exemplary coffee maker in this general category is the Cuisinart™ DCC-450 4 cup coffee maker which is electrically rated as 120 Vac, 60 Hz, and 550 W. Another such coffee maker is the Jura Capresso 10 cup coffee maker, model 475.05.

Continuing with FIG. 1, arrows showing the typical path of water during brewing. The reservoir for holding water opens to a flexible cold tube 35 below that extends between the reservoir and the heating conduit 50 for heating the water. A one-way valve 40 is positioned at some point between the reservoir and the heating conduit 50. In this embodiment the one-way valve is much closer to the reservoir, although embodiments where the valve is closer to the heating conduit or midway between the two are also possible. In this embodiment the valve is in a vertical part of the water path, although it may also be in a more horizontal portion. The one-way valve is preferably a check valve, more preferably a ball check valve, and most preferably an improved, modified ball check valve of the present invention.

The cold tube 35, which may simply be room temperature, eventually leads to a heating vessel of some kind, which is preferably a tubular heating conduit 50 but which may take other forms. In this exemplary embodiment the heating conduit is a horseshoe-shaped metal tube which forms a passage for the water, although the full shape of the heating conduit is not visible from the angle of FIG. 1. From this viewpoint, the heating conduit 50 curves away from the viewer and into the page at the left side, and would eventually curve back to the right to join the hot tube 36. A heating element 52 is closely engaged to the heating conduit 50 and, powered by electricity, heats the heating conduit 50 and thereby heats the water inside the conduit. In preferred embodiments the same heating element 52 simultaneously heats the carafe heater 13 area and thereby warms the carafe 5 above. The heating conduit and the heating element may take the form of extruded, tandem aluminum tubes. The heating element and conduit each preferably have the shape of a horseshoe or semi-circle.

The heating conduit leads to a hot tube 36 which may be insulated. The hot tube is part of a path guiding hot water and/or steam from the heating conduit to a shower head 32 which will typically be near the top of the coffee maker. A steam condenser 54 may optionally be in the hot tube path after the hot water leaves the heating element. The shower head 32 is positioned above a filter basket 25 and typically distributes hot water over different parts of the basket through a number of openings. An opening at the bottom of the filter basket 25 leads directly or indirectly into a container below such as a carafe. In this embodiment, a filter basket 25 slides into and out of the body for adding and removing grounds, instead of accessing the basket from above.

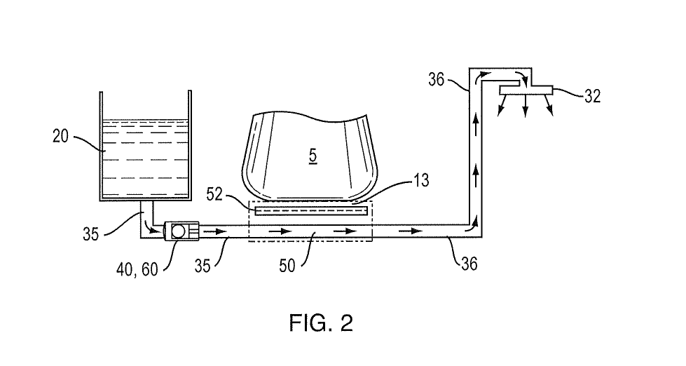

FIG. 2 schematically shows the path of water through a drip coffee maker. Room temperature or colder water is poured into the reservoir 20 and passes through the hole at the bottom of the reservoir and into the flexible cold tube 35 below. Then the water flows through a one-way valve 40 and into one of the two extruded tandem aluminum tubes which is the heating conduit 50 of the preferred heating system. The other tube is the heating element 52. The water continues out of the heating conduit and up through another flexible tube—the hot tube 36—connected to the other end of the heating system and an attached vertically-oriented tube 36. The hot tube 36 can comprise a variety of flexible and non-flexible conduits, and is not limited to tubular shaped conduits.

When the automatic drip coffee maker is actuated, the heating element 52 in the other tube of the heating system starts heating and makes the water in the adjoining tube—the heating conduit 50—boil. Expansion caused by the heating helps to push the heated water and steam through the system. The heating conduit and the heating element of the heating system are not limited to the preferred tandem tube arrangement. The heating element may be an elongated element which has the same general shape as the heating conduit which traces a path parallel to all or part of the heating conduit. The heating element will typically be connected to a source of electricity 18, to controls 17 for controlling the coffee maker operation and/or the carafe heater, and to a thermostat or other means to automatically turn the element on and off to prevent overheating.

When the water in the heating conduit 50 boils, bubbles form and rise up. Preferably the tubes are small enough and the bubbles are big enough so that a column of water rides up atop the bubbles. The heated water can form steam which expands and increases the pressure in the heating conduit. Preferably a one-way valve is positioned to prevent or minimize the escape of hot, pressurized water and steam back towards the water reservoir, and so that the pressure can only escape by carrying the hot fluids forward through the hot tube 36 towards the shower head.

As water leaves the heating conduit 50, the pressure in the conduit drops and some or all of the hot water leaves via the hot tube 36. This allows the one-way valve 40 to open and new fresh, cold water to flow into the heating chamber. The pressure and weight of water in an elevated reservoir may help push cold water through the system, and to bias the valve towards an open position. Intermittent pressure created by heating water in the conduit provides a balancing pressure in the opposite direction, pushing the valve towards a closed orientation when the pressure is sufficiently strong. New water entering the conduit from the cold tube is heated, generating pressure and closing the one way valve again, and the process repeats itself until all of the water is depleted from the reservoir.

As illustrated by the arrows in FIGS. 1 and 2, the water is pushed up the vertically-oriented tube 36 and into the showerhead 32 that acts to spread the water out evenly onto the coffee grounds below. The hot water flows through the ground coffee beans and into the coffee pot below.

Hot water can thus be delivered from the heating conduit 50 to the shower head 32 and the coffee in a series of frequent pulses. Each pulse may be characterized by water in the conduit heating and expanding, the pressure closing the one way valve, and carrying the hot water out towards the hot tube 36. As the pressure holding the valve closed dissipates, the valve re-opens under gravity and/or the pressure of the cold water, the water being higher than the conduit 50. The allows cold water from the direction of the reservoir to enter the heating conduit. Once again the water is heated, the expansion closes the valve again and propels the next pulse of water into the hot tube, and the cycle continues. As will be explained in detail below, the Applicants have found that varying the shape and weight of the valve materials has a substantial effect on this cycle, and that improved valves can deliver hotter water to the coffee grounds earlier in the brew cycle than conventional valves.

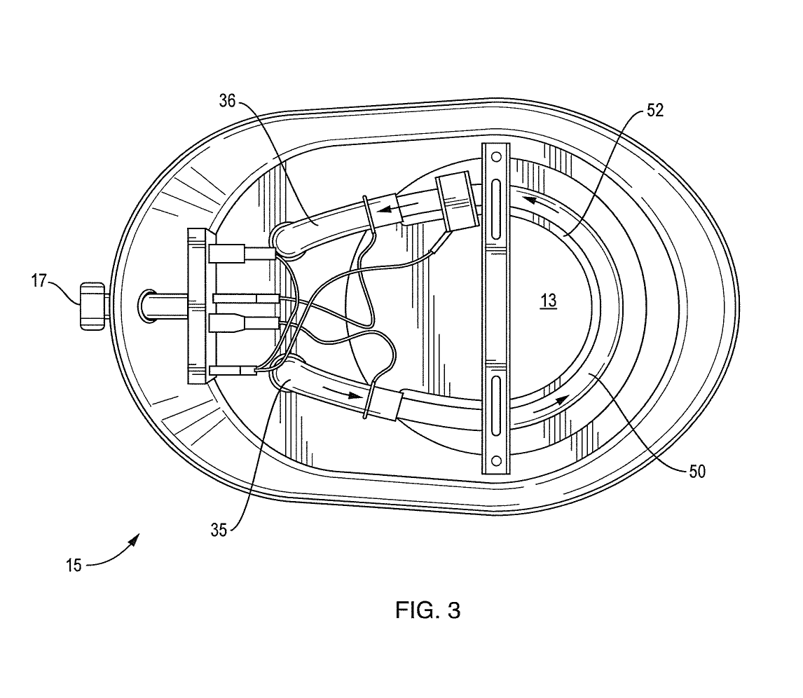

FIG. 3 shows a bottom view of a drip coffee maker with a bottom panel removed so that the inside of the coffee maker base 15 is visible. A flexible cold tube 35 brings water from the reservoir to the heating conduit 50. A heating element 52 follows the path of, and is partially obscured by, the conduit 50. Water flows into and through the heating conduit 50 where it is heated, and then flows out via the hot tube 36 and up towards the shower head. From this perspective the water both arrives from and departs into the plane of the figure. The heating conduit 50 and heating element 52 are in a preferred horseshoe shape in this embodiment. The heating element is adjacent to the lower surface of the carafe heater 13, and in this embodiment also heats the carafe heater 13. A one-way ball valve within the cold tube 35 is not visible in this view. The general direction of travel of water is shown by arrows. At left a control element 17 is shown, in this embodiment a knob. Any drip coffee maker control known in the art can be used with the present invention.

### One Way Ball Valves

A critical feature of the brewing process of an automatic drip coffee maker involves the one-way valve, which is generally located in a path connecting the bottom of the reservoir to one end of the heating system. The valve may be inside a length of flexible tubing, or may be at the junction of two separate tubes or other conduits. This valve, when open, allows water from the reservoir to flow toward the heating system. It also prevents the boiling water from being pushed backwards towards the reservoir by using the valve stop to selectively close off the hole in the valve. Consequently, when the heating conduit is full of pressurized hot water and/or steam, the pressure closes the one-way valve and also pushes the hot fluid out the other end of the heating system, up the vertically-oriented tube and towards the showerhead. Without a one-way valve restricting one of the two ways out of the heating conduit 50, the pressurized boiling water could move backwards into the reservoir, and would also have less energy available to compel it in the desired forward direction.

As mentioned above, the one-way valves used in drip coffee makers have generally been simple ball valves with a lightweight, round, glass or plastic bead as the stopper. The inventors have found that the performance of drip coffee makers can be substantially improved by using the valves of the present invention, including valves with non-spherical alternatives to the simple ball valves used in the prior art.

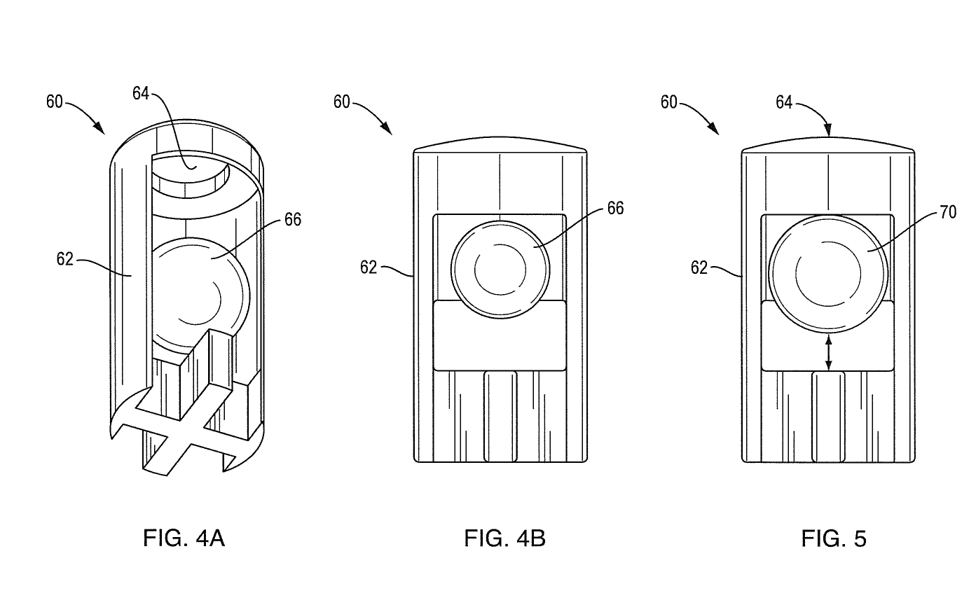

FIGS. 4a and 4b are examples simple ball valves 60 which are typical of the prior art. The valves shown in FIGS. 4a-4b and subsequent figures can be positioned within a conduit, such as a flexible tube, which provides side walls to confine the valve stop within the housing during normal use. The ball valves 60 include a valve housing 62, and a movable valve stop 66 which moves axially within the valve housing. The valve housing may be plastic or another material. Here the valve stops 66 are spherical plastic beads. The valve stop/ball can fit against the valve seat 64 which is shaped to form a seal with the valve stop 66 to prevent the passage of liquids when the stop is positioned against the seat 64. The valve body or housing 62 typically has two openings—one for water to enter, which is identical to or closely associated with the valve seat 64, and another for water to leave, which will usually be opposite the valve seat. In use the valve seat opening should be oriented towards the direction of the reservoir for receiving cold water, while the second opening should be closer to, and should open towards, the heating conduit.

In some embodiments the axis of the valve 60 is oriented vertically, with water traveling down from the reservoir through the valve to the heating arrangement further below. In such arrangements the valve seat 64 will be at or near the top of the valve housing, and the valve stop 66 must be pushed upwards against gravity, and possibly also against the pressure of water in the reservoir above, to close the valve.

FIG. 4a shows a valve in an open configuration where the ball is not engaged to the seat, which would allow cold water to enter via the valve seat opening 64 and flow into and through the valve 60 past the ball 66. If the ball in FIG. 4a is pushed against the valve seat, such as by a flow of liquid in the opposite direction, the ball will substantially or entirely block the flow out liquid out through the valve seat 64 opening, and the valve will be in a closed orientation. FIG. 4b is a side view of the same valve. The axial movement of the valve stop is limited by the valve housing including, at one end, the valve seat. At the end opposite the valve seat a variety of structures could be used to maintain the valve stop 66 in the housing. Preferably opposite end structures which do not form a seal with the stop and allow easy passage of liquid around the stop and towards the heating unit are used.

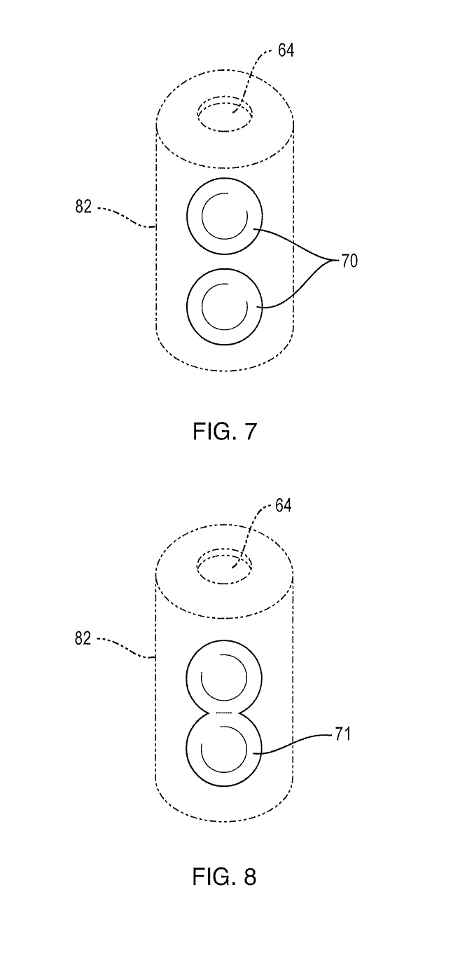

The term “ball valve” 60 as used herein refers to both prior art ball valves using simple light balls as in FIGS. 7 and 8, and also to improved valves of the present invention, including embodiments where the “ball” is a valve stop which is not spherical. A ball valve 60 is a preferred type of one way valve 40.

### Valve Dimensions

The heating system in many automatic drip coffee makers uses a tandem extruded tube arrangement, whereby the water flows through one tube 50 and the heater 52, usually a tubular heating element, rides inside the adjacent tube, as shown in FIG. 3. The inside diameter of the water tube must be properly sized in order for hot water to be effectively pushed up the tube and into the showerhead, and also to drive a significant amount of water with each water pumping cycle so that the full brewing cycle is not too long. If the water tube/heating conduit 50 has too small an internal diameter, water in the tube will flash to steam quickly, but very little water will be delivered to the grounds during each pumping cycle, and the water that is delivered will tend to be cooler. If the inside diameter of the water heating conduit 50 is too large, it will take longer for the water in the heater assembly to flash to steam, and it may also take some time to generate a “slug” of steam in the heating conduit powerful enough to drive the water ahead of the slug up the water tube and onto the grounds from the showerhead. Therefore, the inside diameters of the water tubes of many automatic drip coffee makers are often at or around ⅜ inches. The inside diameters could also be within +/−5%, +/−10%, +/−15% or +/−25% of ⅜ inches, between ¼ and ½ inch or, less often, between ⅛ to ¾ inches. The diameter of the heating conduit 50 largely dictates the sizes of the tube 35 leading to the heating conduit and, therefore, of the one-way check valve 40 and its ball, which are often located inside the water tube.

### Valve Stop Weights and Dimensions

FIGS. 4a-4b show valve stoppers of the prior art 66. FIGS. 5-11 depict improved valves and improved stoppers of the present invention. The improved stoppers may be heavy spheres such as steel spheres 70, single or bonded pairs of spheres 71, or columnar and bullet-shaped stoppers 80. The improved stoppers are all preferably made of a dense material, such as metal, most preferably steel. An alternative preferred embodiment is a stopper comprising both metal and plastic. For example, plastic coated metal, including plastic coated steel.

The lighter the weight of the movable part 66 in the ball valve assembly 60, the easier it is for the movable valve part to be pushed up against the valve seat 64 around the one-way valve inlet hole by pressurized hot fluid, closing the valve and forcing water in the opposite direction out through the showerhead and onto the coffee grounds. Therefore, using the light balls 66 of the prior art ball valves 60, less steam and heat are required to move the ball and close the valve, each aliquot of water thus spends less time in the heating conduit, and the temperature of the water ahead of the steam slug will be correspondingly low.

The inventors have found that as the movable valve stop 66,70,71,80,90,91,92 becomes heavier, more force is needed to raise and push the valve stop against the valve seat 64, and a larger and more forceful steam pocket must be generated to drive the movable part 66,70,80 in the valve upwards or sideways to close the valve. Consequently, the water ahead of the steam slug will have been in proximity to the heater assembly longer, and that water will be hotter. However, importantly, if the weight of the ball 66 is to great, then more water in the tube will turn into steam and very little hot water in the critical 195 to 205 degrees F. range will actually reach the grounds. Water will be lost as steam, and the amount of coffee actually brewed may be reduced.

Prior art plastic valve balls may weigh in the neighborhood of 0.1 g or less, and may have a diameter of about 0.231 inches. As will be explained in greater detail below, the intention provides heavier, preferably larger, preferably steel or metal valve balls. The preferred weight ranges for the improved heavy ball valve stops 70 are therefore about 1 g, 0.9-1.1 g, 0.8-1.2 g, 0.7-1.3 g, 0.5-1.5 g, 0.3-2.0 g, 1.0-2.0 g, and 1.0-3.0 g. Preferred weights also include 0.8 g+/−5%, +/−10%, +/−15%, +/−25%, +/−35% or +/−50%, and 1.0 g+/−5%, +/−10%, +/−15%, +/−25%, +/−35% or +/−50%. The exact diameter of the ball can vary, and will need to match the size of the valve housing and the valve seat. Preferred sphere diameters for use with the invention include about 0.219″, about 0.25″, 0.24-0.26″, 0.23-0.28″, 0.2-0.3″, 0.18-0.4″, and 0.15-0.5″. Preferred diameters also include 0.219″+/−5%, +/−10%, +/−15%, +/−25%, +/−35% or +/−50%, and 0.25″+/−5%, +/−10%, +/−15%, +/−25%, +/−35% or +/−50%. Said weights and diameters are contemplated in all possible combinations.

The preferred weight ranges for columnar and bullet shaped valve stops 80, also called pistons, include about 3.0 g, 2.8-3.2 g, 2.5-3.5 g, and 2.0-4.0 g. Preferred weights also include 3.0 g+/−5%, +/−10%, +/−15%, +/−25%, +/−35% or +/−50%. Preferred piston diameters include about 0.25″, 0.24-0.26″, 0.23-0.28″, 0.2-0.3″, 0.18-0.4″, and 0.15-0.5″. Preferred piston diameters also include 0.25″+/−5%, +/−10%, +/−15%, +/−25%, +/−35% or +/−50%. Preferred piston lengths include about 0.25″, about 0.375″, and about 0.5″. Alternative lengths include 0.22-0.27″, 0.2-0.3″, 0.3-0.4″, 0.27-0.38″, 0.25-0.45″, 0.48-0.52″, 0.45-0.55″, 0.4-0.6″, 0.3-0.6″, and 0.3-1.0″. Further alternative lengths include 0.25″, 0.375″, and 0.5″, each being alternatively +/−5%, +/−10%, +/−15%, +/−25%, +/−35% or +/−50%. Said weights, lengths, and diameters are contemplated in all combinations. In the claims, the terms “columnar” “column-shaped” “piston” or “piston shaped” includes elongated stoppers which are generally flat at both ends, stoppers which are bullet shaped 80,90,91,92, and columnar stoppers which are rounded at both ends.

The preferred combined weight ranges for both loose and bonded double ball valve systems include about 2.0 g, about 2.1 g, 1.8-2.2 g, 1.7-2.3 g, 1.5-2.5 g, and 1.2-3.0 g. Preferred combined weights also include 2 g+/−5%, +/−10%, +/−15%, +/−25%, +/−35% or +/−50%. Each loose or bonded ball can have the same preferred diameter described above with regard to individual balls. The various weights and diameters are contemplated in all practicable combinations.

Although pistons and other stoppers far heavier than the prior art ball stoppers are contemplated, there is a limit to how heave piston stoppers should be. Once temperatures rise sufficiently in the heating element/water tube assembly, the limiting thermostat or thermistor opens the circuit and shuts power to the coffee maker. After cooling down somewhat, the thermostat or thermistor closes the circuit and heating resumes. The piston cannot be too heavy or else temperatures in the heating element/water tube assembly will exceed the calibration temperatures of these components and the coffee maker will start cycling on and off, adversely extending the brewing cycle. A heavy piston can also raise the ambient temperature of water so much as to cause excessive steam. In that case, little or no pumping of water occurs and the brewing cycle is interrupted.

It should be remembered that the invention, which might sound superficially similar to standard valves, contemplates stoppers which are about 10-30 times heavier, and often in very different shapes, than the light prior art ball stoppers. These deceptively simple, elegant modifications provide surprisingly large improvements in the water heating cycle, and in the resulting coffee. As discussed in greater detail below and shown in Table 2a, the improved valves can reduce the time required to provide hot water in the desired brewing range by over 40% (7 minutes vs. 4 minutes), and can increase the amount of time that desired water temperatures are achieved during a given cycle by a factor of five (1 minute vs. 5 minutes).

### Stroke Length

Generally, when the valve is open, the valve stop 66 will be pushed to the downstream, opposite end of the valve housing 62 with regard to the seat 64 by the pressure of passing water arriving from the reservoir and/or by gravity. To close the valve, the valve stop must be pushed axially back towards the valve seat a certain distance, which distance will depend on the size and shape of the valve housing as well as the dimensions of the stop itself. The inventors have found that the greater the axial distance the movable part 66,70,71,80 or ball must travel to return to the seat 64, the more time is required to close the valve, and the less hot water is delivered by each pump cycle. It is therefore most preferred that the valve stop have an optimized range of axial motion, piston travel distance, or “stroke length” within the valve housing 62,72,82.

A preferred travel distance for single steel ball, double steel ball, and column or bullet shaped stops is about 0.24″. Further preferred travel distances include 0.24″+/−5%, +/−10%, +/−15%, +/−25%, +/−35% or +/−50%. Additional preferred travel distances are 0.23-0.25″, 0.22-0.26″, and 0.2-0.3″. Possible travel distances also include 0.06″, 0.104″, 0.19″, 0.31″, 0.34″, 0.44″, 0.56″, 0.69″, and 0.72″, each being alternatively +/−5%, +/−10%, +/−15%, +/−25%, +/−35% or +/−50%.

### Valve Body Dimensions

The valve body must be shaped to accommodate the valve stop being used, including by having a valve seat which is complimentary to the stop, and by having an inside space which creates the desired stroke length for the stop. The key dimensions for the valve body include the outside diameter (“OD”), the inside diameter (“ID”), the inside length, and optionally the top and bottom openings. The diameters and lengths may be adjusted to accommodate larger and smaller stops of various shapes.

Outside diameters may be about 0.375″ or 0.34″, each being alternatively +/−5%, +/−10%, +/−15%, +/−25%, +/−35% or +/−50%. Outside diameters may also be 0.33-0.35″, 0.3-0.4″, 0.2-0.5″, 0.32-0.36″, or 0.36-0.4″.

Inside diameters may be about 0.27″ or 0.28″, each being alternatively +/−5%, +1-10%, +/−15%, +/−25%, +/−35% or +/−50%. Inside diameters may also be 0.26-0.3″, 0.25-0.32″, 0.26-0.29″, 0.2-0.4″, or 0.2-0.6″. The inside diameter may also be selected to match the diameter of the stopper it is to be used with, preferably +5%, +10%, +15%, +25%, +35%, or +50% to allow the stopper to move freely and to allow water to flow around the stopper when the valve is open.

Inside lengths may be about 0.335″, 0.563″, or 0.937″, each being alternatively +/−5%, +/−10%, +/−15%, +/−25%, +/−35% or +/−50%. Inside lengths of 0.5-0.6″, 0.4-0.7″, 0.9-1.0″, 0.8-1.0″, 0.8-1.2″, 0.7-1.3″, and 0.6-1.5″ are also possible. The inside length may also be determined by combining the length of the stopper being used and the desired stroke length.

Various possible combinations of the above valve body dimensions are all within this scope of this disclosure.

It should be noted that the stroke length may be approximately the inside length of the valve body less the diameter (for spheres) or length (for elongated stops) of the stop. Stop lengths and diameters, inside lengths, and stroke distances which are calculated or estimated using that relationship are therefore also contemplated.

Different stop lengths can be achieved in a single valve body by providing one or more holes through the body, and inserting an object such as a Teflon rod though the hole to limit the axial range of motion of the piston inside.

### Relationship Between Ball Weight, Pumping Cycle Duration, and Water Temperatures

A brewing cycle generally lasts from when the coffee maker is turned on, until the water in the reservoir has been exhausted. Most of the water will be heated and delivered to the coffee grounds, although some water may be lost as unrecovered steam. It takes a number of pump cycles to exhaust the water supply in the reservoir, but how long this takes varies between embodiments. Factors such as how long each pump cycle takes, and how much water each pump cycle uses, will affect the total brew cycle time.

The inventors have found that as the time required to complete a brewing cycle goes up, the temperature of the hot water reaching the shower head also goes up. Further, as heavier and more substantial valve stops 66 are used, the brewing cycle tends to be longer, and higher water temperatures are achieved. It is understood that when more force is required to press the movable valve stop 66 against the valve seat 64, more steam is required to achieve that extra force, which requires additional time to generate, and most or all the water will spend more time in the heating conduit 50 being heated during each pumping cycle. If the weight of the valve stop 66 is reduced, less steam power and time are required to close the valve each pumping cycle, and the overall pump cycle time is reduced. If the weight is increased, more steam power is required to close the valve each time, each pump cycle will be longer, and the water will be hotter because it spends more time in the heating conduit.

Similarly, the time required to complete each brewing cycle (which includes many successive water heating cycles) is increased as the temperature of the water delivered through the showerhead to the grounds is increased. More steam must be created to generate the force required to press the movable part 66 against the valve opening 64. Generally as the weight of the valve stop 66 is decreased, the overall brew cycle time is reduced, and as the weight is increased, the brew cycle time is increased. For instance, using a columnar-shaped valve stop 80 which will be described in greater detail below, brew cycle time was increased an average by 17 percent as compared to using a standard valve with the plastic bead ball valve stop 66. I.e. 7 minutes 26 seconds using the standard light plastic ball, compared to 8 minutes 43 seconds using a columnar valve stop 66. As will be also discussed in greater detail, the columnar valve of the present invention also resulted in delivering hot water at preferred temperatures earlier in the brew cycle.

Generally the longer that hotter water at the desired temperatures contact the coffee grounds, the greater the extraction of coffee flavor from the grounds. A more effective, efficient process for extracting coffee flavor should mean that less coffee is required to achieve a given level of flavor. Alternatively, better, stronger flavor can be extracted from the same amount of grounds. Experiments supporting this application show that a coffee maker using an elongated, piston-like valve stop 80 delivered hot water in the preferred 195° F. to 205° F. to the grounds about three minutes earlier in the brew cycle than a coffee maker using a standard light ball valve. This is a substantial improvement when a typical drip coffee brewing cycle may only be about 7-8 minutes in total.

It is also preferred that the piston not be too heavy, or else temperatures in the heating element/water tube assembly will exceed the calibration temperatures of these components and the coffee maker will start cycling on and off, adversely extending the brewing cycle. An overly-heavy piston can also raise the temperature of water so much that most or all of it becomes steam. When too much steam is produced, little or no liquid water is actually pumped towards the coffee grounds, and the brewing cycle is interrupted or less effective.

### Improved One-Way Valve Arrangements

Drip coffee makers with novel and improved one-way valves are therefore provided. These valves have been shown to be clearly advantageous in side-by-side tests compared with the prior art coffee makers using standard ball valves. Table 1 is provided for a comparison of the attributes of some valves that were tested, and which are discussed further below.

The prior art ball valve 60 shown at FIGS. 4a-4b is the type currently used in coffee makers such as the Cuisinart™ DCC-450 four cup automatic drip coffee maker, which was used for some comparison trials herein to show the advantages of the new valves. The bead valve stop 66 in this exemplary standard valve weighs not more than about 0.1 grams, with a diameter of about 0.21 inches. The inside diameter of the valve housing 62 is about 0.28 inches, and the valve stop 66 was able to move axially about 0.14 inches to open and close the valve.

### Steel Ball Valves

FIG. 5 shows an improved ball valve for use in a coffee maker which uses a steel ball 70 weighing about 1 gram as the valve stop 70 inside the same type of valve housing 62 shown in FIGS. 4a-4c. In FIG. 5 the steel ball 70 is inside the housing 62 for valve operation. The depicted steel ball is larger than the plastic ball, having a diameter of about 0.25 inches. In FIG. 5 an arrow indicates the directions of axial movement of the ball within the housing, which movement is general to the other valves of the invention. In operation the steel ball is positioned against the valve seat 64 opening when the valve is closed, and the ball is away from the seat 64 when the valve is open for the passage of water.

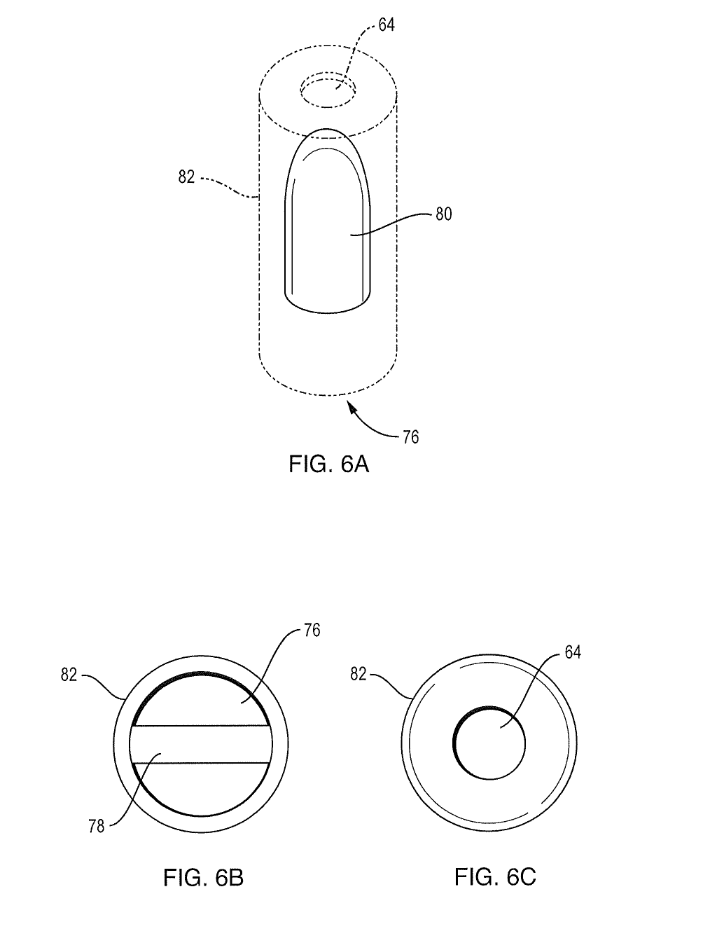

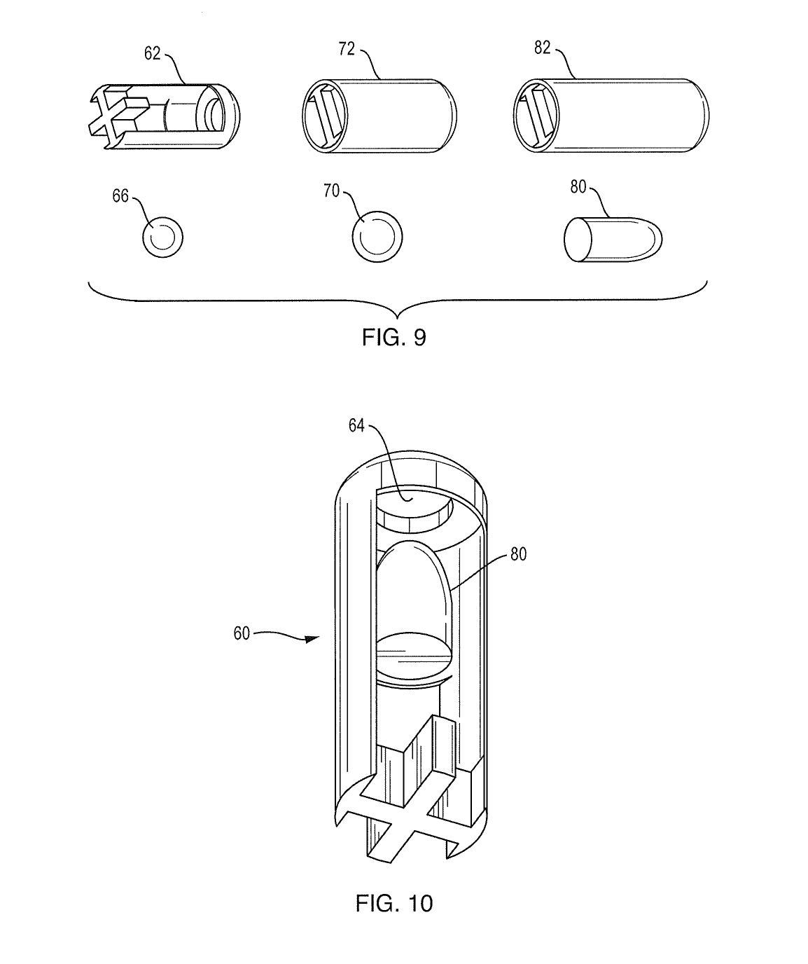

The depicted steel ball 70 can also be used with longer and/or closed housings 72,82,95,96 such as shown in FIG. 9 and FIG. 12. The valve cases or housings serve the same general functions as the comparison housing 62, though with advantageous different shapes and dimensions. A preferred new valve case 72 includes openings at each end. In FIG. 6c a valve opening 64 is visible, with the inner side of the valve opening, which is not visible, functioning as a valve seat 64 for reversibly forming a seal with the stopper when the valve is closed. FIG. 6b shows the opposite open end 76 of the valve case 72, which preferably allows the passage of fluids regardless of the location of the stopper, but is shaped to maintain the stopper in the housing, such as with a cross-element 78.

The inside diameter of the improved valve case 72,82 is preferably about 0.28 inches, and the steel ball valve stop 70 is able to move axially further than with the standard valve housing 62, about 0.24 inches, to open and close the valve.

Steel balls with diameters of about 0.23-0.27, 0.2-0.3, 0.15-0.4, 0.1-0.5, and 0.05-1 inches are considered within the scope of this invention. Valve casings and housings having correspondingly sized interior diameters and valve seats are also within the scope of the invention. Balls made from other materials, preferably dense materials such as alternative metals or ceramics, are also possible. Balls having weights of about 0.9-1.1, 0.8-1.2, 0.6-1.5, 0.5-2.0, 0.3-3.0, and 0.1-10.0 grams are all within the scope of the invention.

### Columnar, Piston, and Bullet-Shaped Valve Stops

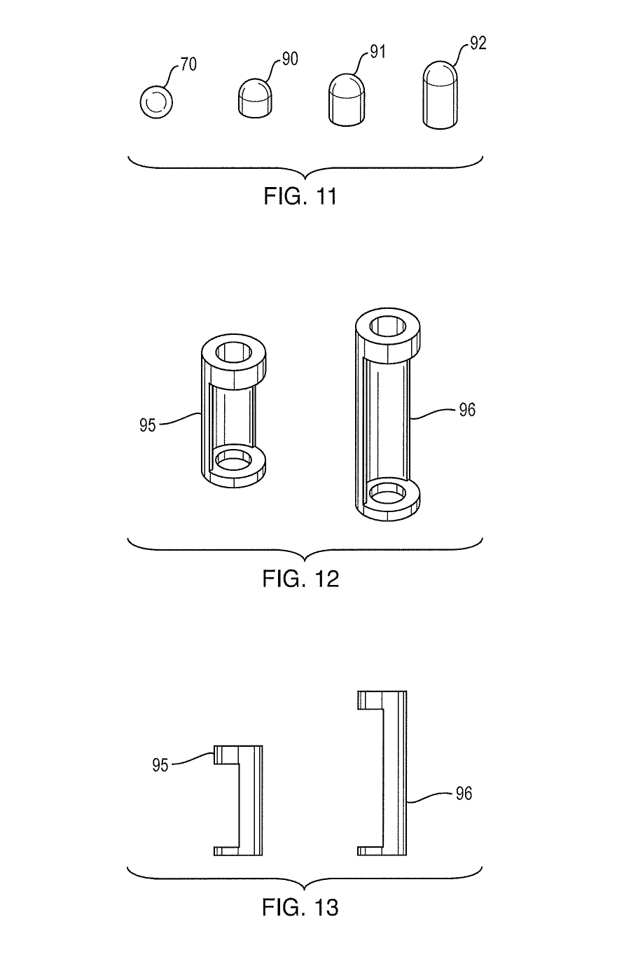

FIGS. 6a and 10 depict a particularly preferred type of one way valve for use with coffee makers. This embodiment features an elongated columnar or piston-shaped valve stop 80. Either or both ends may be flat, or optionally be rounded, domed, pointed, or tapered. In the depicted embodiment, which resembles a bullet, one end of the column is tapered to form a better seal with a valve seat 64 by fitting partially within the valve seat 64 opening inside the valve. FIG. 11 shows bullet-shaped valve stops of three different lengths 90,91,92 compared with a spherical metal stopper 70.

The columnar valve stop 80 can be used to form a valve with a variety of housings. The depicted embodiment uses a valve case 82 is similar to, though longer than, the valve case 72 depicted at FIG. 9 and tested with the steel ball 70, though the valve case embodiment 82 used in the instant tests with the column was slightly longer. This valve case was also used with two loose steel balls and with two bonded steel balls, as described below. The case also facilitated studies into the effects of changing the travel distance of the valve stop—the axial stroke length—during the brewing process.

FIG. 10 is an alternative valve 60 using a bullet shaped stop 80. The housing in this embodiment is open on the sides unlike the housing in FIG. 6a.

The valve case depicted and used for the comparison tests has a 0.28 inch interior diameter. Interior diameters of 0.25-0.3, 0.2-0.35, 0.18-0.4, 0.2-0.5, and 0.1-1.0 inches are all considered within the scope of the invention. The depicted valve case is internally sized to allow the valve stop an axial range of movement of about 0.24 inches. Axial ranges of movement of about 0.14, 0.2-0.3, 0.1-0.2, 0.1-0.3, 0.1-0.4, 0.05-0.3, 0.1-0.6, and 0.05-1.0 are all considered within the scope of the invention. The tubular valve case 82 at FIGS. 6a-6c includes an open end 76 at one end and a valve opening, which doubles as a valve seat, at the opposite end. The valve seat 64 at the inner side of the valve opening is shaped for engaging the valve stop 80 to reversibly close the valve. The columnar valve stop 80 slides axially within the valve case to open and close the one way valve. The open end 76 is preferably always open for passage of water, although a means 78 may be provided to block the valve stop from axially sliding out of the valve case 82. The movement of the valve stop will typically be limited by housing and/or cold tube walls closely surrounding it radially, and by a valve seat at one end of a cavity, and a means 78 blocking the open end 76 at the far opposite end of the cavity.

Variations on the columnar valve stop can include tin-can shapes with two flat ends, pill shapes with straight sides two rounded ends, or pill shapes which are entirely tapered and are widest in the center and narrower at the ends. The column preferably has a cross sectional diameter small enough for free axial movement within the valve casing and to allow sufficient water flow around it when the valve is open. The depicted column 80 is about 0.52 inches in length at its maximum. Columns having lengths of about 0.45-0.6, 0.4-0.7, 0.4-0.8, 0.3-1.0, and 0.1-1.5 inches are within the scope of the invention. The depicted column had a weight of about 3 grams, although columns with weights of about 2.8-3.2, 2.5-3.5, 2.0-4.0, 1.0-5.0, 1.0-7.0, and 0.1-10.0 grams each are all considered within the scope of the invention. The depicted column is steel, though columns comprising metals other than steel, and using plastics, ceramics, or other materials of sufficient density, as also possible.

In the claims, the terms “columnar” “column shaped” “piston” or “piston shaped” include columnar stoppers which are generally flat at both ends, stoppers which are bullet shaped 80,90,91,92, and columnar stoppers which are rounded at both ends.

### Double Ball Valve Stops

FIG. 7 shows the components of a one way valve arrangement where a valve case 82 similar to the one used with the columnar valve stop was used with a pair of loose steel balls 70, each being similar to the single steel ball shown in FIG. 5. Each steel ball weighs approximately 1 gram, for a total of about 2 grams. Although as a practical matter only one of the two balls 70 could engage the valve seat to close the valve, both balls are collectively considered to be the valve stop.

FIG. 8 shows another valve stop of the present invention which consists of two steel balls bonded together—a conjoined valve stop 71—each ball being otherwise similar to the separate steel balls in FIGS. 5 and 7. The valve casing was similar to the valve casing 82 used for the column and for the two loose steel balls. The total weight of the conjoined valve stop was about 2.1 grams. The weight of a conjoined valve stop may be considered the combined weight of the individual steel balls, optionally plus about 0.1 gram to account for bonding material such as weld, solder, or adhesive material. Conjoined valve stops may be a combination of two individual balls, or alternatively a single component with a shape approximating the shape of conjoined balls.

The combined length of both the loose and conjoined double steel balls, each being about 0.25 inches, was approximately 0.5 inches. Steel balls with diameters of about 0.23-0.27, 0.2-0.3, 0.15-0.4, 0.1-0.5, and 0.05-1 inches are considered within the scope of this invention, as are loose and conjoined pairs of balls with those dimensions. Valve casings and housings having correspondingly sized interior diameters, lengths, and valve seats are also within the scope of the invention. Balls made from other materials, preferably dense materials such as alternative metals, are also possible. Balls having weights of about 0.9-1.1, 0.8-1.2, 0.6-1.5, 0.5-2.0, 0.3-3.0, and 0.1-10.0 grams are all within the scope of the invention. In the case of conjoined valve stops, the weights may be approximately double the weight of the individual component balls+0.1 gram. The cross-sectional diameter at the widest points will be about the same as the diameter of the individual balls, though the length will be approximately the combined diameter of the individual balls.

### Comparison of Valve Embodiments and General Properties of Valves

FIG. 9 shows various one way valve components side by side. At the left are the prior art valve housing 62 and plastic ball 66 which are believed to be standard in drip coffee makers. At center are the valve casing 72 and 70 steel ball used in the single steel ball valve discussed above. The ball is the same or similar to the one used for the loose and conjoined double steel ball valves. At right are the longer valve casing 82 and a columnar valve stop 80 that can be used with the columnar valve embodiment. This longer valve casing 82 can also used with the double ball valve embodiments.

Table 1 compares the dimensions of one way valves which were used in a first set of experiments which support this disclosure, and which are discussed in more detail below. The experiments compared the performance of different general types of valves using light prior art stoppers, steel ball stoppers, double ball stoppers, and columnar stoppers. These dimensions should be viewed as preferred embodiments where applicable, but are not limiting.

All embodiments of valve cases and housings for use with this invention are preferably internally shaped or tapered to guide the valve stop to the valve seat. This can be in the form of tapering which narrows going from an end of a cavity opposite the valve seat to the narrower valve seat. The valve cases and housings all preferably include an open end opposite the valve seat which is open for passage of water regardless of the position of the valve stop, but which are sized or include a blocking means which prevents the valve stop from axially sliding out of the case or housing. Typically the valve seat will be a round opening having a diameter somewhat narrower than the internal diameter of the main area of the housing where the valve stop is free to move. The valve seat may resemble an internal cross-section of a cone. All of the valves are preferably inserted into a tube connecting the reservoir to the heating system, although other locations are possible.

It will be understood that hot and cold tube arrangements can be provided with diameters corresponding and proportional to the diameters of the valve housings they will be used with. In a preferred embodiment, the valve is positioned inside a cold tube having an internal diameter closely matching the external diameter of the valve.

Heavier and denser valve stops are generally preferred. Steel valve stops are preferred, though other metals, plastics, and other materials can be used alone or in combination. In all cases, the piston should be made of rustproof and heat tolerant materials, such as 300 series stainless steels, steel with a protective coating like plastic, or glass that can be exposed to higher temperatures and are acceptable for use with foods. Other materials can be used, but designs may have to be modified to accommodate their lighter or heavier weights.

Experimental Comparisons: Improved Valves Vs. Standard Valve

The inventors ran a series of experiments to compare the performance of drip coffee makers using the conventional light ball one-way valves and the new valves which the inventors believed would provide advantages. The experiments compared the temperature of the water reaching the showerhead, immediately over the coffee grounds, over the course of a brew cycle. The experiments showed that the inventors' improved valves, particularly the valves using a columnar valve stop, provided water at the preferred temperatures over 195° F. much earlier in the brewing cycle, and as a result for a much greater portion of the brew cycle, than the conventional valve the coffee maker came equipped with. The results of these experiments are summarized at tables 2a and 2b. Time points when the water at the shower head is at a desired temperature of 195° F. or greater are bolded.

These experiments were conducted as follows:

Objective: Using the same automatic drip coffee maker with different one-way valve systems, measure the time it takes for the water delivered to the coffee grounds to reach the optimal temperature range the brewing cycle.

Method:

(1) Provide a Cuisinart™ model DCC-450 4-cup, automatic drip coffee maker, rated at 120 VAC, 60 Hz, 550 W.

(2) Provide calibrated Omega model HH21 microprocessor, and Leeds & Northrup Co. recording thermometers, to measure water temperatures.

(3) Position thermocouples in the outlet of the coffee maker showerhead to measure water temperature during the brewing process.

(4) The same coffee maker was used to brew three batches of coffee using each of the valves: as-received (control) valve, steel ball valve, columnar stop valve, double loose steel ball valve, and conjoined double steel ball valve. For each configuration of one-way valve systems, brew three four-cup batches of coffee, starting each batch with the automatic drip coffee maker at room temperature.

The configurations tested included: [Table 2a] the as-received valve system (bead weight: <0.1 g), the valve system with the smaller new valve housing and the steel ball (ball weight: about 1 g), the valve system with the larger new valve housing 82 and the columnar-shaped valve stop (column weight about 3 g), the valve system with the new valve housings 72 and [Table 2b] valve stops of two loose steel balls (weight about 2 g total), and the new valve housing and a pair of bonded steel balls (weight about 2.1 g). The valve system dimensions were as listed in Table 1.

(5) Record the water temperatures continuously and at discrete points in the brew cycle at the showerhead, i.e. just before the water is released to the grounds.

Aside from replacing the valve systems, no other changes were made to the automatic drip coffee maker. Thus, differences in performance can be fairly attributed to the various valves.

Results: Tables 2a and 2b summarize the results over time, with water temperatures of at least 195° F. in bold. Bold numbers reflect temperatures in the optimal range or higher (where steam is emitted at the end of the cycle). The temperatures at time 0 minutes refer to the water temperature in the reservoir at the beginning of the cycle.

Based on the test data presented and other data collected to date by the inventors, it appears that the valve systems using one or more steel balls for the valve stop permit the standard automatic drip coffee maker to heat water to the optimal temperature above 195° F., most preferably 195° F.-205° F., more quickly that the control as-received system using a light ball valve.

Further, the valve system with the new valve housing and the columnar-shaped valve stop allowed the water to reach the optimal temperature range in the fastest time, by the 4^{th} minute, as shown in table 2a, and came extremely near 195° F. by the 3^{rd} minute. The control, as-received valves did not reach the desired range until at least the 7^{th} minute, and in one case the 8^{th} minute. Since the entire brewing cycle was only between seven and nine minutes using this coffee maker, this means that the controls only provided water at the desired temperature at the very end of the cycle. The column valve, in contrast, provided water above 195° F. for more than half of the brewing cycle, starting by the four minute mark of brew cycles which lasted longer than eight minutes. The improved columnar stop valves can reduce the time required to reach the desired brewing range by over 40% (7 minutes vs. 4 minutes), and can increase the amount of time that desired water temperatures are achieved during a given cycle by a factor of five (1 minute vs. 5 minutes).

Therefore, in preferred embodiments using elongated stoppers such as column or bullet shaped stoppers, the water at the shower head reaches 195° F. by the 4th minute, and/or the water at the shower head is at least 195° F. for at least 50% of the brew cycle, and/or the water at the shower head is at least 170° F. within one minute or within two minutes of starting the brew cycle.

The total brew cycle time increases slightly when using valve stops with either one or more steel balls, or with a columnar-shaped valve stop. This may be a result of each pulse of water spending more time in the heating conduit, which also results in the water being heated to higher temperatures. Compared with the as-received control system, brew cycle times were extended by an average of less than 4 percent with the steel ball valve stop, by 14 percent with the columnar-shaped valve stop, by about 4 percent with the two loose steel balls, and by about 9 percent with the two bonded or conjoined steel ball valve stops.

### Experimental Comparisons: Different Columnar Valve Stops

Having demonstrated the particular superiority of valves using a heavy, bullet or cylinder shaped stopper, further tests were conducted comparing different combinations of conical stops 80 and housings 72,82.

For this battery of experiments, the model DCC-450 4-cup, automatic drip coffee maker, rated at 120 VAC, 60 Hz, 4.6 A, was used again. A larger Jura Capresso model 475.05, 10-cup coffee maker, rated at 120 VAC, 60 Hz, 8.2 A, was also used to compare the performance of larger and smaller units.

FIG. 11 shows three bullet-shaped, piston stoppers. These particular stops are a ¼″ piston 90, a ⅜″ piston 91, and a ½″ piston 92. A spherical steel ball stop 70 is also depicted for comparison, corresponding to Metal Ball 2 in Tables 3-5. The ¼″ and ½″ pistons 90,92 were used for this set of tests. The weight and diameter of these pistons, as well as of two metal balls stops and a standard light plastic ball stop, are provided for comparison at Table 3.

FIG. 12 shows perspective views of short 95 and long 96 valve housings of the type used in this set of tests. FIG. 13 shows the same valve housings from the side. Table 4 compares the dimensions of the test valve housings, as well as a standard as-received valve housing 62 similar the one shown at FIGS. 4a-4b.

Table 5 compares the piston travel distance or axial “stroke length” of different stops in different housings. The ¼″ Piston and the ½″ Piston were each tested and compared in both the long and short body housings for this trial.

This set of experiments was conducted using the same test equipment and procedures from the set of experiments described above except as noted. The DCC-450 4-cup (“4 Cup”) used previously, and in addition a Jura Capresso model 475.05, 10-cup coffee maker (“10 Cup”), were each tested using each of four different stop valve arrangements. The four arrangements were the long 96 and the short 95 valve bodies described in Table 4, each alternatingly with a short ¼″ Piston 90 and then with a long ½″ Piston 92.

The results for the 4 Cup trials are summarized at Table 6, and the results for the 10 Cup tests are summarized at Table 7. Similar to the first battery of experiments, the numbers represent the temperatures of water exiting the showerhead of each coffee maker.

Based on a review the plots of time versus temperature (in degrees F.) for the 4 Cup, reflected numerically in Tables 6, the arrangement with the shortest net piston stroke (short body, longer ½ inch piston) had the lowest average temperature, while the arrangement with the longest net piston stroke (long body, shorter ¼-inch long piston) had the highest average temperature. Thus, for the 4 Cup size, the piston travel distance had the greatest effect on temperature. It is believed that greater piston travel distance or “stroke length” causes each aliquot of water to spend more time being heated in the heating conduit.

Interestingly, using the 10 Cup coffee maker, a larger, higher capacity and higher wattage unit than the 4 Cup model, it appears that greater piston weight has the stronger correlation with higher average temperatures. Stroke length remains very significant, however, as shown in Table 7.

Based on these experiments, most-preferred valves include columnar stoppers inside relatively long valve housings. Such valve housings have preferred inside lengths of about 0.937 inches+/−5%, +/−10%, +/−15%, +/−25%, +/−35% or +/−50%. Alternative preferred inside lengths include 0.92-0.95″, 0.9-1.0″, 0.8-1.1″, 0.7-1.2″, and 0.6-1.4″.

Also based on these experiments, valves with columnar stoppers having longer stroke distances are often preferred. Most-preferred stroke lengths include 0.69″+/−5%, +/−10%, +/−15%, +/−25%, +/−35% or +/−50%. Alternative preferred stroke lengths include 0.44″+/−5%, +/−10%, +/−15%, +/−25%. Further preferred stroke lengths include 0.6-0.8″, 0.5-0.9″, 0.4-1.0″, 0.4-0.8″, 0.3-0.9″, and 0.3-1.0″.

Preferred valves also include heavy, elongated piston stoppers. Most preferred pistons may be rounded at one or both ends, and may be bullet shaped. Preferred piston stoppers are preferably made of a dense material, preferably metal, most preferably steel. Preferred pistons have a diameter of 0.250″+/−5%, +/−10%, +/−15%, +/−25%, +/−35% or +/−50%. Preferred pistons are between about ¼″ and ½″ in length. Preferred lengths include 0.5″+/−5%, +/−10%, +/−15%, +/−25%, +/−35% or +/−50%, and 0.25″+/−5%, +/−10%, +/−15%, or +/−25%. Preferred lengths also include 0.45-0.55″, 0.4-0.6″, 0.3-0.7″, 0.2-0.6″, and 0.35-0.8″. Preferred pistons weigh about 1.4 g or 3.1 g ″+/−5%, +/−10%, +/−15%, +/−25%, +/−35% or +/−50%. Preferred pistons also weigh 2.8-3.3 g, 2.5-3.5 g, 2.0-4.0 g, 1.2-1.6 g, 1.0 g-1.8 g, 0.7 g-4.0 g, and 1.0-5.0 g. A particularly preferred piston is ½″ long, weighs 3.1 g, and has a 0.25″ diameter, with each of those attributes being +/−5%, +/−10%, +/−15%, or +/−25%. Another particularly preferred piston is ¼″ long, weighs 1.4 g, and has a 0.25″ diameter, with each of those attributes being +/−5%, +/−10%, +/−15%, or +/−25%.

Most preferred valves include a combination of the pistons described just above and a long valve housing described just above that. Preferably the valves have a most preferred stroke length as also described above. Combinations and sub-combinations of the above embodiments are disclosed and contemplated, with the specific combinations in the test examples being particularly preferred.

The inventor's experiments show that ideal piston shape, size and weight, and the ideal stop valve body size, also depend partially on the size, cup capacity, and wattage of a given coffee maker. Improved brew temperature and extraction depends on the travel distance of the piston in the stop valve body in smaller, lower wattage, low cup-capacity coffee makers with piston stoppers. In contrast, in larger, higher wattage and cup-capacity units, improved brew temperatures are achieved substantially based on the weight of the piston stopper. In large units, the travel distance of the piston within the stop valve body is also important, however. Coffee makers with both ideal piston weight and travel distance are a most preferred application of the instant invention. It is preferred to “tune” each machine embodying the invention to identify the best stop valve based on the embodiments and principles disclosed herein.

The experiments support a conclusion that all size drip coffee makers are likely to benefit from the addition of valves having a columnar stopper, as well as a longer stroke length and a housing sized to provide a longer stroke length. Longer and heavier columnar pistons are also preferred for larger coffee makers, and heavier columnar stoppers appear to do no harm and possibly provide some incremental benefit in smaller coffee makers as well. The invention also includes using the improved valves to deliver hot water for uses other than brewing coffee.

### CONCLUSION

The invention is conceived of as including improved valves, coffee makers including improved valves, methods of making coffee and other hot liquids using the improved valves, valve components having different shapes and dimensions, heavy columnar and bullet-shaped valve stops, valves with relatively long stroke lengths, and all other combinations and uses of the elements discussed above.

While a specific embodiment of the invention has been shown and described in detail to illustrate the application of the principles of the invention, it will be understood that the invention may be embodied otherwise without departing from such principles.

TABLE 1
Key Dimensions of Valve Systems
Used in Test Program (in inches)

| | | | Valve | Optimal |
|---|---|---|---|---|
| | Valve | | Housing | Travel |
| | Stop | | Inside | Distance of |
| Item | Diameter | Length | Diameter | Valve Stop |
| As-received ball or | About .21 | | 0.28 | 0.14 |
| bead | | | | |
| Steel Ball | 0.25 | | 0.28 | 0.24 |
| Column | 0.25 | 0.52 | 0.28 | 0.24 |
| Two Steel Balls | 0.25 | 0.50 | 0.28 | 0.24 |
| (Loose and Bonded) | | | | |

TABLE 2a
Valve Systems with As-Received, Steel Ball and Columnar-Shaped Valve Stops

| | | | | | | | Columnar- | Columnar- | Columnar- |
|---|---|---|---|---|---|---|---|---|---|
| | As-Recvd | As-Recvd | As-Recvd | Steel Ball | Steel Ball | Steel Ball | shaped | shaped | shaped |
| Time | Valve | Valve | Valve | Valve | Valve | Valve | valve stop | valve stop | valve stop |
| (in minutes) | (Run 1) | (Run 2) | (Run 3) | (Run 1) | (Run 2) | (Run 3) | (Run 1) | (Run 2) | (Run 3) |
| 0 (temp in | 60 | 62 | 63 | 70 | 70 | 63 | 50 | 60 | 65 |
| reservoir) | | | | | | | | | |
| 1 | 166 | 163 | 163 | 163 | 161 | 163 | 170 | 171 | 180 |
| 2 | 179 | 169 | 171 | 179 | 180 | 180 | 186 | 183 | 183 |
| 3 | 179 | 173 | 176 | 183 | 173 | 182 | 189 | 194 | 194 |
| 4 | 181 | 170 | 182 | 183 | 193 | 180 | 200 | 196 | 196 |
| 5 | 184 | 174 | 183 | 193 | 189 | 194 | 202 | 203 | 200 |
| 6 | 184 | 188 | 183 | 202 | 194 | 203 | 201 | 202 | 204 |
| 7 | 193 | 201 | 202 | 206 | 204 | 201 | 202 | 206 | 208 |
| 8 | 203 | | | | 204 | 207 | 204 | 208 | 209 |
| Cycle time | 7:58 | 7:32 | 7:23 | 7:22 | 8:06 | 8:14 | 8:40 | 9:52 | 9:38 |
| (in min:sec) | | | | | | | | | |

TABLE 2b
Valve Systems with Two Steel Balls (Loose) and Two Steel Balls (Bonded)

| | Two Balls | Two Balls | Two Balls | Two Balls | Two Balls | Two Balls |
|---|---|---|---|---|---|---|
| Time | (Loose) | (Loose) | (Loose) | (Bonded) | (Bonded) | (Bonded) |
| (in minutes) | (Run 1) | (Run 2) | (Run 3) | (Run 1) | (Run 2) | (Run 3) |
| 0 (temp in | 70 | 70 | 70 | 70 | 70 | 70 |
| reservoir) | | | | | | |
| 1 | 144 | 171 | 159 | 169 | 161 | 170 |
| 2 | 162 | 179 | 168 | 181 | 177 | 191 |
| 3 | 168 | 188 | 169 | 178 | 182 | 189 |
| 4 | 173 | 187 | 173 | 187 | 191 | 193 |
| 5 | 154 | 198 | 191 | 183 | 193 | 191 |
| 6 | 196 | 201 | 193 | 198 | 193 | 201 |
| 7 | 206 | 209 | 203 | 204 | 199 | 202 |
| 8 | | 210 | | 206 | 206 | 209 |
| Cycle time | 7:43 | 5:11 | 7:55 | 8:03 | 6:56 | 6:12 |
| (in min:sec) | | | | | | |

TABLE 3
Valve Pistons - Critical Dimensions (dimensions
in g where marked, and inches otherwise

| | As-Received | Metal | Metal | ¼″ | ⅜″ | ½″ |
|---|---|---|---|---|---|---|
| Dimension | Plastic Ball | Ball 1 | Bail 2 | Piston | Piston | Piston |
| Weight | <0.1 g | 0.8 g | 1.0 g | 1.4 g | 2.2 g | 3.1 g |
| Diameter | .231 | .219 | .250 | .250 | .250 | .250 |
| Length | | | | .250 | .375 | .500 |

The ¼″ Piston and the ½″ Piston are the pistons in Tables 6-7.

TABLE 4
Valve Body/Housing Dimensions (dimension in inches)

| Dimension | As-Received | Long | Short |
|---|---|---|---|
| OD | .375 | .340 | .340 |
| ID | .270 | .280 | .280 |
| Inside Length | .335 | .937 | .563 |
| Top opening | .162 | .187 | .187 |
| Bottom opening | .205 | | |

The Long and Short valve bodies are the Housings in Tables 6-7.

TABLE 5
Piston Travel/Stroke Length (in inches)

| Body | As-Received | Metal | Metal | ¼″ | ⅜″ | ½″ |
|---|---|---|---|---|---|---|
| Type | Plastic Ball | Ball 1 | Ball 2 | Piston | Piston | Piston |
| As- | .104 | | | | | |
| received | | | | | | |
| Long | | .72 | .69 | .69 | .56 | .44 |
| | | | | (lon- | | |
| | | | | gest) | | |
| Short | | .34 | .31 | .31 | .19 | .06 |
| | | | | | | (shortest) |

The Stroke Lengths under the ¼″ Piston and ½″ Piston headings are the stroke lengths in Tables 6-7.

TABLE 6
Coffee Maker: Cuisinart DCC-450 4-Cup

| Housing | Short | Short | Long | Long |
|---|---|---|---|---|
| Piston | ½-inch | ¼-inch | ½-inch | ¼-inch |
| Stroke Length | 4th (shortest) | 3rd | 2nd | 1st (longest) |
| Avg. Temp. | 4th (lowest) | 3rd | 2nd | 1st (highest) |
| Time | Water Temperature (degrees F.) | | | |
| 0 | 71 | 71 | 72 | 72 |
| 1 | 171 | 179 | 180 | 183 |
| 2 | 184 | 179 | 188 | 189 |
| 3 | 186 | 179 | 196 | 195 |
| 4 | 193 | 190 | 200 | 202 |
| 5 | 194 | 192 | 206 | 204 |
| 6 | 203 | 204 | 207 | 209 |
| 7 | 209 | 210 | 208 | 210 |
| 8 | | | | |
| 9 | | | | |
| Cycle Off | 7:34 | 7:06 | 8:10 | 7:48 |

Temperatures in bold are in the optimal range for brewing of 195° F. or higher.

TABLE 7
Coffee Maker: Jura Capresso 475.05 10-Cup

| Housing | Short | Long | Short | Long |
|---|---|---|---|---|
| Piston | ¼-inch | ¼-inch | ½-inch | ½-inch |
| Stroke Length | 3rd | 1st (longest) | 4th (shortest) | 2nd |
| Avg. Temp. | 4th (lowest) | 3rd | 2nd | 1st (highest) |
| Time | Water Temperature (degrees F.) | | | |
| 0 | 72 | 71 | 72 | 72 |
| 1 | 178 | 171 | 170 | 173 |
| 2 | 178 | 176 | 181 | 183 |
| 3 | 182 | 180 | 185 | 188 |
| 4 | 190 | 180 | 191 | 202 |
| 5 | 195 | 202 | 192 | 201 |
| 6 | 195 | 195 | 199 | 206 |
| 7 | 203 | 195 | 202 | 208 |
| 8 | 208 | 203 | 203 | 210 |
| 9 | 208 | 204 | 208 | 203 |
| Cycle Off | 9:19 | 9:39 | 9:32 | 10:04 |

Temperatures in bold are in the optimal range for brewing of 195° F. or higher.

What is claimed is:

1. A drip coffee maker, the drip coffee maker comprising:
a reservoir for holding fresh water;
a fresh water passage, the fresh water passage being connected to the reservoir for receiving fresh water from the reservoir;
a heating conduit, the heating conduit being in a base of the coffee maker, the heating conduit being elongated and being connected to the fresh water passage for receiving fresh water therefrom;
a heating element, the heating element being adjacent to the heating conduit, the heating element being linked to an electrical source, the heating element being capable of heating water in the heating conduit when the drip coffee maker is in operation;
a hot water passage, the hot water passage being connected to the heating conduit for receiving hot water therefrom, the hot water passage leading to a shower head, the shower head being positioned over a filter basket for distributing hot water received from the hot water passage over the filter basket;
a one-way valve positioned in the fresh water passage, the valve comprising a movable stopper and a housing, the valve being positioned so that fresh water traveling from the reservoir to the heating conduit passes through the valve, the valve being oriented so that water moving backwards from the heating conduit towards the reservoir will bias the valve towards a closed configuration;
wherein the valve stopper is column-shaped, comprises steel, is from 0.4 to 0.6 inches long, weighs from 2.0 to 3.5 grams, and has a diameter from 0.2 to 0.3 inches; and
wherein the valve housing has an inside length such that the stopper has an axial stroke length inside the housing of from 0.3 to 0.8 inches.

2. The drip coffee maker of claim 1:
wherein the valve housing comprises a valve seat, the valve seat being at an end of the housing which is oriented towards the reservoir and away from the heating conduit;
wherein a portion of the valve stopper has a shape which is complimentary to the valve seat;
wherein when the one-way valve is in the closed configuration, the stopper is engaged to the valve seat and substantially blocks passage of water through the valve.

3. The drip coffee maker of claim 2, wherein the stopper is bullet-shaped, having a generally flat end and a domed end, and
wherein the domed end of the stopper is complimentary to and oriented to releasably engage with the valve seat in the closed configuration.

4. The drip coffee maker of claim 1:
wherein the stopper is bullet-shaped, having a generally flat end and a domed end, and
wherein the stopper is from 0.45-0.55 inches long and weighs from 2.7-3.3 grams.

5. The drip coffee maker of claim 4, wherein the valve housing has an inside length such that the stopper has a stroke length of from 0.35 to 0.55 inches.

6. A drip coffee maker, the drip coffee maker comprising:
a reservoir for holding fresh water;
a fresh water passage, the fresh water passage being connected to the reservoir for receiving fresh water from the reservoir;
a heating conduit, the heating conduit being in a base of the coffee maker, the heating conduit being elongated and being connected to the fresh water passage for receiving fresh water therefrom;
a heating element, the heating element being adjacent to the heating conduit, the heating element being linked to an electrical source, the heating element being capable of heating water in the heating conduit when the drip coffee maker is in operation;
a hot water passage, the hot water passage being connected to the heating conduit for receiving hot water therefrom, the hot water passage leading to a shower head, the shower head being positioned over a filter basket for distributing hot water received from the hot water passage over the filter basket;
a one-way valve positioned in the fresh water passage, the valve comprising a movable stopper and a housing, the valve being positioned so that fresh water traveling from the reservoir to the heating conduit passes through the valve, the valve being oriented so that water moving backwards from the heating conduit towards the reservoir will bias the valve towards a closed configuration;
wherein the valve stopper is column-shaped.

7. The drip coffee maker of claim 6:
wherein the housing comprises a valve seat;
wherein the stopper is bullet-shaped, having a generally flat end and a domed end; and
wherein the domed end of the stopper is complimentary to the valve seat, and engages with the valve seat in the closed configuration.

8. The drip coffee maker of claim 6, wherein the stopper comprises plastic-coated metal.

9. The drip coffee maker of claim 6, wherein the stopper comprises steel.

10. The drip coffee maker of claim 6, wherein the stopper is from 0.4 to 0.6 inches long, and has a diameter from 0.2 to 0.3 inches.

11. The drip coffee maker of claim 6, wherein the valve housing has an inside length such that the stopper has an axial stroke length inside the housing of from 0.3 to 0.8 inches.

12. The drip coffee maker of claim 6:
wherein the stopper is metallic;
wherein the stopper is from 0.4 to 0.6 inches long and has a diameter from 0.2 to 0.3 inches; and
wherein the valve housing has an inside length such that the stopper has an axial stroke length inside the housing of from 0.35 to 0.6 inches.

13. The drip coffee maker of claim 12, wherein the coffee maker has a capacity of at least eight cups.

14. The drip coffee maker of claim 6, wherein the stopper is metallic, and weighs between 2.5-3.5 grams.

15. The drip coffee maker of claim 6, wherein the stopper is metallic, and weighs between 1.0 and 4.0 grams.

16. The drip coffee maker of claim 6, wherein the valve housing has an inside length such that the stopper has an axial stroke length inside the housing of from 0.3 to 0.8 inches; and
wherein the coffee maker has a capacity of no more than five cups.

17. The drip coffee maker of claim 6:
wherein the valve stopper is bullet-shaped, having a generally flat end and a domed end; and
wherein the stopper is metallic, is from 0.2 to 0.7 inches long, and weighs from 1.0 to 4.0 grams.

18. The drip coffee maker of claim 6:
wherein the stopper is metallic, is from 0.2 to 0.7 inches long, and weighs from 1.0 to 4.0 grams; and
wherein the valve stroke length is from 0.20 to 1.0 inches.

19. A method of brewing coffee using the drip coffee maker of claim 6:
wherein the method comprises providing at least four cups of fresh water to the reservoir and then performing a brew cycle, thereby brewing at least four cups of coffee;
wherein the brew cycle comprises incrementally passing fresh water in the reservoir into the fresh water conduit, through the one-way valve, and into the heating conduit, heating the water in the heating conduit, and then passing the heated water through the hot water passage, thence into the showerhead and onto coffee grounds below the showerhead;
wherein the one-way valve substantially prevents hot water in the heating conduit from moving backwards towards the reservoir;
wherein the hot water delivered to the showerhead is at least 195° F. for at least half of the duration of the brew cycle.

20. The method of brewing coffee using a drip coffee maker according to claim 19:
wherein the coffee maker has a capacity of not more than five cups;
wherein the valve housing has an inside length such that the stopper has an axial stroke length inside the housing of from 0.3 to 0.8 inches;
wherein each brew cycle takes at least seven minutes; and
wherein the hot water delivered to the showerhead is at least 195° F. by the fourth minute of the brew cycle, for substantially the remainder of the brew cycle.
